(19) United States
(12) Patent Application Publication
(10) Pub. No.: US 2014/0046660 A1
(43) Pub. Date: Feb. 13, 2014

(54) METHOD AND SYSTEM FOR VOICE BASED MOOD ANALYSIS

(71) Applicant: Gaurav KAMDAR, Bangalore (IN)

(72) Inventor: Gaurav KAMDAR, Bangalore (IN)

(73) Assignee: Yahoo! Inc, Sunnyvale, CA (US)

(21) Appl. No.: 13/571,365

(22) Filed: Aug. 10, 2012

(51) Int. Cl. G10L 15/26

(52) U.S. Cl. 704/235; 704/E15.043

(57) ABSTRACT

A computer-implemented method for voice based mood analysis includes receiving an acoustic speech of a plurality of words from a user in response to the user utilizing speech to text mode. The computer-implemented method also includes analyzing the acoustic speech to distinguish voice patterns. Further, the computer-implemented method includes measuring a plurality of tone parameters from the voice patterns, wherein the tone parameters comprises voice decibel, timbre and pitch. Furthermore, the computer-implemented method includes identifying mood of the user based on the plurality of tone parameters. Moreover, the computer-implemented method includes streaming appropriate web content to the user based on the mood of the user.

### TECHNICAL FIELD

Embodiments of the disclosure relate generally, to monetization and more specifically, to analyze mood of users using voice patterns.

### BACKGROUND

Creating new business opportunities and monetization strategies for publishing on the web is a vast area of growth. The growth demands for additional and effective monetization for publishers of web sites and applications.

One monetization strategy that exists is to stream web content based on mood analysis of users. The mood analysis identifies mood of the user while the user keys in messages of text on a mobile device, for example on a laptop. Alternatively, the mood can also be identified by analyzing the user during browsing. However, depending on text to identify the mood does not result in accurate results all the time.

With advancement in technology, keying messages of text will turn out to be a thing of the past. Speech recognition techniques are taking over the world. In due time, the speech recognition techniques would probably want the user to speak only to perform any kind of operations on the mobile device. An existing speech recognition technique that performs speech recognition is referred to as whole-word template matching. Here, when an isolated word is spoken, the system compares the isolated word to each individual template which represents vocabulary of the user. Consequently, mood analysis according to the advancement of technology is essential.

In light of the foregoing discussion, there is a need for an efficient method and system for analyzing moods to enhance monetization.

### SUMMARY

The above-mentioned needs are met by a computer-implemented method, computer program product, and system for voice based mood analysis.

An example of a computer-implemented method for voice based mood analysis includes receiving an acoustic speech of a plurality of words from a user in response to the user utilizing speech to text mode. The computer-implemented method also includes analyzing the acoustic speech to distinguish voice patterns. Further, the computer-implemented method includes measuring a plurality of tone parameters from the voice patterns. The tone parameters comprise voice decibel, timbre and pitch. Furthermore, the computer-implemented method includes identifying mood of the user based on the plurality of tone parameters. Moreover, the computer-implemented method includes streaming appropriate web content to the user based on the mood of the user.

An example of a computer program product stored on a non-transitory computer-readable medium that when executed by a processor, performs a method for voice based mood analysis includes receiving an acoustic speech of a plurality of words from a user in response to the user utilizing speech to text mode. The computer program product includes analyzing the acoustic speech to distinguish voice patterns. The computer program product also includes measuring a plurality of tone parameters from the voice patterns. The tone parameters comprise voice decibel, timbre and pitch. Further, the computer program product includes identifying mood of the user based on the plurality of tone parameters. Moreover, the computer program product includes streaming appropriate web content to the user based on the mood of the user.

An example of a system for voice based mood analysis includes a voice-user interface. The voice-user interface initiates a speech to text mode on a user mobile device. The system also includes an audio input module that receives an acoustic speech of a plurality of words from the user. Further, the system includes an analyzing module that analyzes the acoustic speech to distinguish voice patterns. Furthermore, the system includes a computing module that measures a plurality of tone parameters in the voice patterns. The system also includes a mood analyzer that identifies mood of the user based on the tone parameters.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow diagram illustrating a method for voice based mood analysis, in accordance with one embodiment;

FIG. 2 is a block diagram illustrating a system for voice based mood analysis, in accordance with one embodiment; and

FIG. 3 is a block diagram illustrating an exemplary computing device, in accordance with one embodiment.

### DETAILED DESCRIPTION OF THE EMBODIMENTS

A computer-implemented method, computer program product, and system for voice based mood analysis are disclosed. The following detailed description is intended to provide example implementations to one of ordinary skill in the art, and is not intended to limit the invention to the explicit disclosure, as one of ordinary skill in the art will understand that variations can be substituted that are within the scope of the invention as described.

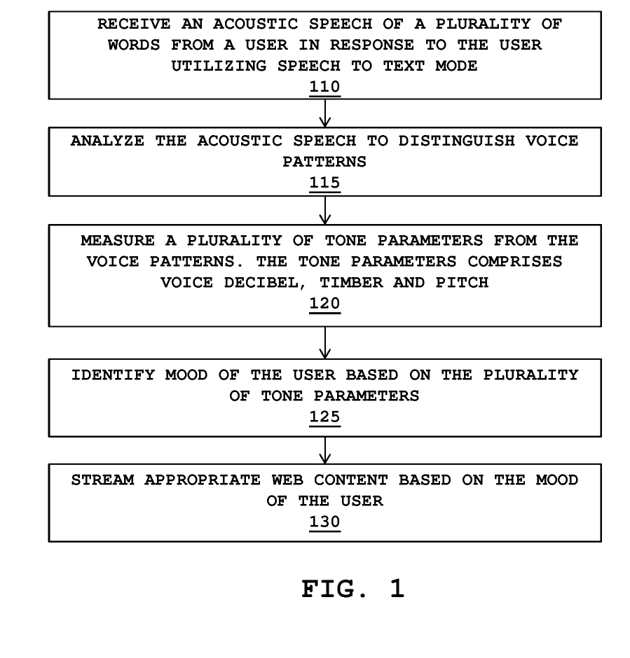

FIG. 1 is a flow diagram illustrating a method for voice based mood analysis, in accordance with one embodiment.

At step 110, an acoustic speech of a plurality of words is received from a user in response to the user utilizing a speech to text mode.

The user often desires to write messages on mobile devices that enable a speech to text mode. Examples of the mobile devices include, but are not limited to, iphone-Siri, android and win. In some embodiments, the user desires to make voice calls in general on the mobile devices. In such a scenario, the user speaks to the mobile device on a microphone. Subsequently, an acoustic speech of a plurality of words is received by the mobile device.

In some embodiments, the mobile devices can include, for example desktop computers, laptops, PDAs and cell phones.

Accordingly, data is collected from the acoustic speech. The data includes a plurality of frames of speech in which the acoustic speech is defined. Further, the acoustic speech is stored in a database.

At step 115, the acoustic speech is analyzed to distinguish voice patterns.

Once the frames of speech are analyzed, a distinctive manner of oral expression is identified as voice patterns. Examples of the voice patterns include, but are not limited to, a very slow voice pattern and a clear voice pattern.

Further, the mobile device is trained by a machine learning algorithm that prepares the mobile device to learn various voice patterns of the user.

A library of voice templates is created and stored in the database. The voice templates are voice samples of the user spoken in the past.

At step 120, a plurality of tone parameters from the voice patterns is measured. Examples of the tone parameters include, but are not limited to, voice decibel, timbre and pitch.

The voice decibel is used to quantify sound levels. For example, a normal speaking voice falls in the range of 65-70 dB.

Timbre also known as tone quality and tone color, which distinguishes the voice patterns from other sounds of the same pitch and volume.

Pitch refers to the highness and lowness of a tone perceived by the human ear.

At step 125, the mood of the user is identified based on the tone parameters.

Consequently, the tone parameters upon measuring distinguish ranges of voice decibels that identify the mood with which the user has spoken to the mobile device. For example, high voice decibels and strain in voice distinguishes that the user was angry. Similarly, a feeble voice of lower voice decibels signifies that the user was sad. Examples of the moods includes, but is not limited to, anger, fear, sadness, frustration, stress, curiosity and happiness.

Further, the voice patterns are mapped with corresponding voice templates of the user. Given that the voice templates are samples of voice patterns in the past, the mapping channels the way to derive a matching voice template. Consequently, the voice template distinguishes a corresponding mood of the user.

For example, consider that consequent to the training on the mobile device with a plurality of voice templates, it is comprehended that normal voice of the user falls in the range of 60-70 dB. At this moment, a new voice pattern is received from the user and the tone parameters for the new voice pattern are measured as 80 dB. The tone parameters of the new voice pattern are then mapped with corresponding tone parameters in the voice templates. Consequently, the higher range of dB signifies that the user is angry.

At step 130, appropriate web content is streamed based on the mood of the user.

The web content and advertisements are streamed to the user based on the mood. In some embodiments, the streaming is done in real time. Moreover, the web content streamed moderates the mood of the user. For example, anger in the voice can be moderated by streaming a lively joke.

The streaming of appropriate web content and advertisements results in enhanced monetization.

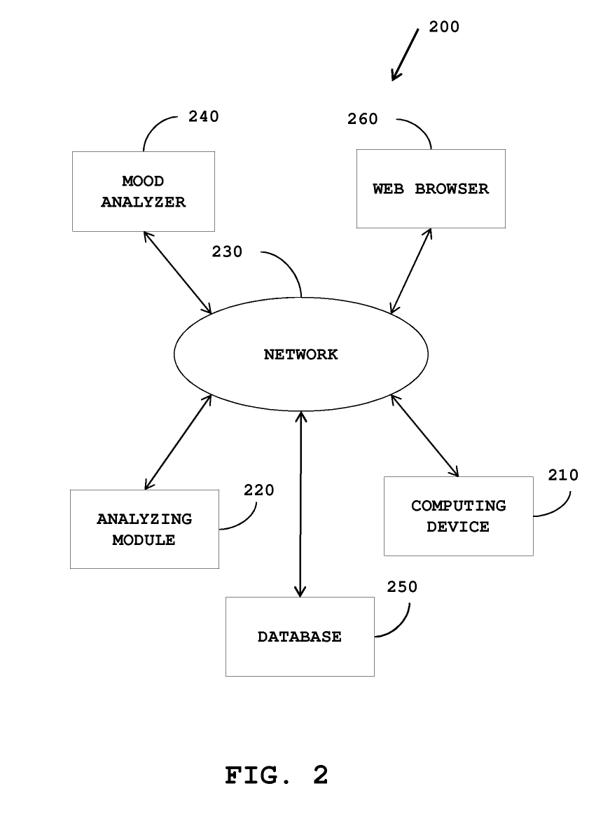

FIG. 2 is a block diagram illustrating a system for voice based mood analysis, in accordance with one embodiment.

The system 200 can implement the method described above. The system 200 includes a computing device 210, an analyzing module 220, a mood analyzer 240, a database 250 and a web browser 260 in communication with a network 230 (for example, the Internet or a cellular network).

The computing device 210 includes a voice to speech interface that initiates a speech to text mode for writing messages. Further, the computing device 210 includes a microphone to facilitate voice calls. In some embodiments, the microphone can be modified with any other audio input means for receiving an acoustic speech of a plurality of words from the user. Furthermore, the computing device includes a converter that converts the acoustic speech of analog signals to digital signals.

Examples of the computing device 210 include, but are not limited to, a Personal Computer (PC), a stationary computing device, a laptop or notebook computer, a tablet computer, a smart phone or a Personal Digital Assistant (PDA), a smart appliance, a video gaming console, an internet television, or other suitable processor-based devices.

Further, the computing device 210 is subjected to a training phase with a machine learning algorithm. The machine learning algorithm trains the computing system 210 to learn voice patterns of users of the computing system 210. Furthermore, the computing device 210 also measures a plurality of tone parameters in the voice patterns. The tone parameters include voice decibel, timbre and pitch.

The analyzing module 220 analyzes the acoustic speech to distinguish corresponding voice patterns of the user.

The mood analyzer 240 identifies the mood of the user based on the tone parameters.

The database 250 stores voice templates of users using the computing device 210. The voice templates represent a basic vocabulary of speech.

The web browser 260 streams appropriate web content and advertisements based on the mood of the user. Consequently, monetization is enhanced.

The user of the computing device 210 desires to write a message through the speech to text mode. In one embodiment, the user desires to make a voice call on the computing device 210. Subsequently, an acoustic speech of a plurality of words is received by the computing device 210. The acoustic speech is then analyzed to distinguish voice patterns. Meanwhile, a plurality of tone parameters are measured from the voice patterns. The tone parameters are then mapped with the voice templates stored in the database 250. Subsequently, a corresponding mood is identified. Based on the mood identified, appropriate web content is streamed to the user. In some embodiments, the web content moderates the mood of the user. In addition, advertisements are also rendered to the user. Hence, monetization is enhanced.

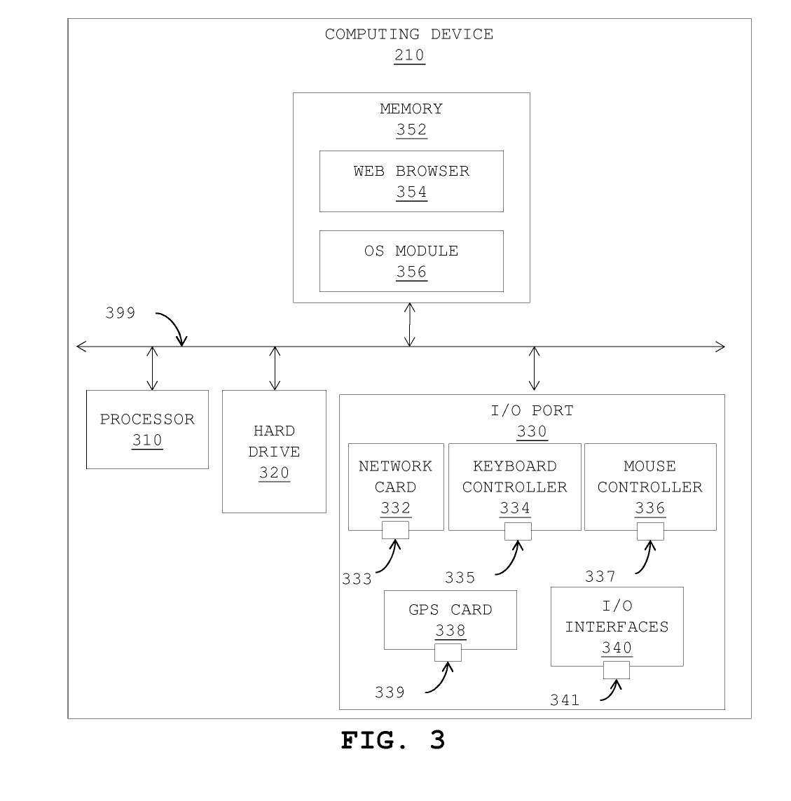

Additional embodiments of the computing device 210 are described in detail in conjunction with FIG. 3.

FIG. 3 is a block diagram illustrating an exemplary computing device, for example the computing device 210 in accordance with one embodiment. The computing device 210 includes a processor 310, a hard drive 320, an I/O port 330, and a memory 352, coupled by a bus 399.

The bus 399 can be soldered to one or more motherboards. Examples of the processor 310 includes, but is not limited to, a general purpose processor, an application-specific integrated circuit (ASIC), an FPGA (Field Programmable Gate Array), a RISC (Reduced Instruction Set Controller) processor, or an integrated circuit. The processor 310 can be a single core or a multiple core processor. In one embodiment, the processor 310 is specially suited for processing demands of location-aware reminders (for example, custom micro-code, and instruction fetching, pipelining or cache sizes). The processor 310 can be disposed on silicon or any other suitable material. In operation, the processor 310 can receive and execute instructions and data stored in the memory 352 or the hard drive 320. The hard drive 320 can be a platter-based storage device, a flash drive, an external drive, a persistent memory device, or other types of memory.

The hard drive 320 provides persistent (long term) storage for instructions and data. The I/O port 330 is an input/output panel including a network card 332 with an interface 333 along with a keyboard controller 334, a mouse controller 336, a GPS card 338 and I/O interfaces 340. The network card 332 can be, for example, a wired networking card (for example, a USB card, or an IEEE 802.3 card), a wireless networking card (for example, an IEEE 802.11 card, or a Bluetooth card), and a cellular networking card (for example, a 3G card). The interface 333 is configured according to networking compatibility. For example, a wired networking card includes a physical port to plug in a cord, and a wireless networking card includes an antennae. The network card 332 provides access to a communication channel on a network. The keyboard controller 334 can be coupled to a physical port 335 (for example PS/2 or USB port) for connecting a keyboard. The keyboard can be a standard alphanumeric keyboard with 101 or 104 keys (including, but not limited to, alphabetic, numerical and punctuation keys, a space bar, modifier keys), a laptop or notebook keyboard, a thumb-sized keyboard, a virtual keyboard, or the like. The mouse controller 336 can also be coupled to a physical port 337 (for example, mouse or USB port). The GPS card 338 provides communication to GPS satellites operating in space to receive location data. An antenna 339 provides radio communications (or alternatively, a data port can receive location information from a peripheral device). The I/O interfaces 340 are web interfaces and are coupled to a physical port 341.

The memory 352 can be a RAM (Random Access Memory), a flash memory, a non-persistent memory device, or other devices capable of storing program instructions being executed. The memory 352 comprises an Operating System (OS) module 356 along with a web browser 354. In other embodiments, the memory 352 comprises a calendar application that manages a plurality of appointments. The OS module 356 can be one of Microsoft Windows® family of operating systems (for example, Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

The web browser 354 can be a desktop web browser (for example, Internet Explorer, Mozilla, or Chrome), a mobile browser, or a web viewer built integrated into an application program. In an embodiment, a user accesses a system on the World Wide Web (WWW) through a network such as the Internet. The web browser 354 is used to download the web pages or other content in various formats including HTML, XML, text, PDF, postscript, python and PHP and may be used to upload information to other parts of the system. The web browser may use URLs (Uniform Resource Locators) to identify resources on the web and HTTP (Hypertext Transfer Protocol) in transferring files to the web.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standards 802.11, 802.11a, 802.11b, 802.11e, 802.11g, 802.11i, and 802.11n). In one example, signals from the computer can be transferred, at least in part, wirelessly to components or other computers.

Advantageously, determining the mood of the user by voice results in more accurate results. Given that voice is a natural response system, the results are more human in nature. Further, easy deployment is achieved since voice to text applications recognizes voice of the user. Moreover, the tone parameters are easily measured even when the user is on a voice call. Consequently, web content and advertisements are streamed based on the mood to the user in real time thereby enhancing monetization.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

1. A computer-implemented method for voice based mood analysis, the computer-implemented method comprising:
receiving an acoustic speech of a plurality of words from a user in response to the user utilizing speech to text mode;
analyzing the acoustic speech to distinguish voice patterns;
measuring a plurality of tone parameters from the voice patterns, wherein the tone parameters comprises voice decibel, timbre and pitch;
identifying mood of the user based on the plurality of tone parameters; and
streaming appropriate web content to the user based on the mood of the user by rendering relevant advertisements to the user based on the mood of the user, whereby monetization is enhanced.

2. The computer-implemented method of claim 1, wherein receiving the acoustic speech further comprises:
collecting data from the acoustic speech, wherein the data comprises of a plurality of frames of speech; and
storing the acoustic speech in a database.

3. The computer-implemented method of claim 1, wherein identifying the mood of the user further comprises
mapping the voice patterns with corresponding voice templates previously stored.

4. The computer-implemented method of claim 3 and further comprising:
creating a library of voice templates of a plurality of users generated in the past; and
storing the library in the database.

5. The computer-implemented method of claim 1, wherein identifying the mood of the user further comprises:
comparing the tone parameters subsequent to the measuring with previously stored tone parameters of the user; and
recognizing a corresponding mood in which the user has spoken the acoustic speech.

6. (canceled)

7. A computer program product stored on a non-transitory computer-readable medium that when executed by a processor, performs a method for voice based mood analysis, comprising:
receiving an acoustic speech of a plurality of words from a user in response to the user utilizing speech to text mode;
analyzing the acoustic speech to distinguish voice patterns;
measuring a plurality of tone parameters from the voice patterns, wherein the tone parameters comprises voice decibel, timbre and pitch;
identifying mood of the user based on the plurality of tone parameters; and
streaming appropriate web content to the user based on the mood of the user by rendering relevant advertisements to the user based on the mood of the user, whereby monetization is enhanced.

8. The computer program product of claim 7, wherein receiving the acoustic speech further comprises:
collecting data from the acoustic speech wherein the data comprises of a plurality of frames of speech; and
storing the acoustic speech in a database.

9. The computer program product of claim 7, wherein identifying the mood further comprises
mapping the voice patterns with corresponding voice templates previously stored.

10. The computer program product of claim 9 and further comprising:
creating a library of voice templates of a plurality of users generated in the past; and
storing the library in the database.

11. The computer program product of claim 7, wherein identifying the mood of the user further comprises:
comparing the tone parameters subsequent to the measuring with previously stored tone parameters of the user; and
recognizing a corresponding mood in which the user has spoken the acoustic speech.

12. (canceled)

13. A system for voice based mood analysis, the system comprising:
a voice-user interface to initiate a speech to text mode on a user mobile device;
an audio input module that receives an acoustic speech of a plurality of words from the user;
an analyzing module that analyzes the acoustic speech to distinguish voice patterns;
a computing module that measures a plurality of tone parameters in the voice patterns;
a mood analyzer that identifies mood of the user based on the plurality of tone parameters; and
a web browser to stream appropriate web content and advertisements based on the mood of the user, whereby monetization is enhanced.

14. The system of claim 13 and further comprising:
a database of voice templates of a plurality of users representing a basic vocabulary of speech.

15. The system of claim 13, wherein the plurality of tone parameters comprises voice decibel, tone and pitch.

16. The system of claim 13 and further comprising
a converter that converts the acoustic speech of analog signals to digital signals.

17. A computer-implemented method for voice based mood analysis, the computer-implemented method comprising:
receiving an acoustic speech of a plurality of words from a user in response to the user utilizing speech to text mode;
analyzing the acoustic speech to distinguish voice patterns;
measuring a plurality of tone parameters from the voice patterns, wherein the tone parameters comprises voice decibel, timbre and pitch;
identifying mood of the user based on the plurality of tone parameters; and
streaming appropriate web content to the user based on the mood of the user, including web content for moderating the mood of the user.

18. A computer program product stored on a non-transitory computer-readable medium that when executed by a processor, performs a method for voice based mood analysis, comprising:
receiving an acoustic speech of a plurality of words from a user in response to the user utilizing speech to text mode;
analyzing the acoustic speech to distinguish voice patterns;
measuring a plurality of tone parameters from the voice patterns, wherein the tone parameters comprises voice decibel, timbre and pitch;
identifying mood of the user based on the plurality of tone parameters; and
streaming appropriate web content to the user based on the mood of the user, including web content for moderating the mood of the user.

19. A system for voice based mood analysis, the system comprising:
a voice-user interface to initiate a speech to text mode on a user mobile device;
an audio input module that receives an acoustic speech of a plurality of words from the user;
an analyzing module that analyzes the acoustic speech to distinguish voice patterns;
a computing module that measures a plurality of tone parameters in the voice patterns;
a mood analyzer that identifies mood of the user based on the plurality of tone parameters; and
a web browser to stream appropriate web content based on the mood of the user, including web content for moderating the mood of the user.
